(19) United States
(12) Patent Application Publication
(10) Pub. No.: US 2024/0242633 A1
(43) Pub. Date: Jul. 18, 2024

(54) MODULAR CRICOTHYROTOMY TRAINING SYSTEM

(71) Applicant: MOCHTECH, LLC, Grover, MO (US)

(72) Inventors: Robb Mourton, Grover, MO (US); Wesley Mourton, Ballwin (JS)

(73) Assignee: MOCHTECH, LLC, Grover, MO (US)

(21) Appl. No.: 18/412,734

(22) Filed: Jan. 15, 2024

Related U.S. Application Data
(60) Provisional application No. 63/439,704, filed on Jan. 18, 2023.

(51) Int. Cl. G09B 23/34

(52) U.S. Cl. CPC G09B 23/34

(57) ABSTRACT

A modular Cricothyrotomy training adjunct for a medical training device having an orifice that opens into an inner chamber. The adjunct includes a base that releasably attaches to the medical training device, and a simulated larynx affixed to the base. Openings extend through the simulated larynx and through the base. The openings align with the medical training device orifice when the base is properly attached to the medical training device to enable Cricothyrotomy training there through. A simulated skin and/or a simulated cricoid membrane may be positioned over the opening.

### CROSS REFERENCE TO RELATED APPLICATIONS

This application derives and claims priority from U.S. provisional application 63/439,704, filed Jan. 18, 2023, and having Attorney Docket No. MOCH H012US, which provisional application is incorporated herein by reference.

### STATEMENT REGARDING FEDERALLY SPONSORED RESEARCH OR DEVELOPMENT

Not Applicable.

### FIELD

The present teachings generally relate to medical training devices, and more particularly to a modular Cricothyrotomy training apparatus and associated components.

### BACKGROUND

The statements in this section merely provide background information related to the present disclosure and may not constitute prior art.

Learning the proper skill and precision for safely and effectively performing a Cricothyrotomy procedure on a patient, particularly a Cricothyrotomy that is to be performed in emergency situations, can be a difficult and onerous process. Such training becomes more complex and complicated when the training must occur at home or under field conditions, a i.e., at locations other than established medical training facilities such as for example at temporary and/or mobile military medical facilities or bases.

Medical personnel whose job responsibilities include performing Cricothyrotomy procedures on patients must be trained and certified for that skill set. That skill set also requires regular practice to maintain proficiency and recertification. In addition, in emergency situations or in military battlefield circumstances, a timely and proper Cricothyrotomy procedure can mean the difference between life and death for an injured patient. That is, proper and effective Cricothyrotomy training can prepare a medical responder to timely and properly treat a leading cause of preventable death in a traumatic emergency—i.e., suffocation due to a blocked airway in the throat. Consequently, in addition to benefiting medical personnel in performing routine Cricothyrotomy procedures, ongoing training and practice of proper Cricothyrotomy procedure techniques by emergency responders and military troops is therefore critically important.

Traditional Cricothyrotomy training devices are designed for classroom settings. Such devices typically include a replicated human body part (e.g., a head and neck, or torso), and focus on anatomical correctness—not convenience. Most require support components (e.g., pumps and monitors) that link to the anatomical component with tubes and wires. Traditional Cricothyrotomy trainers are therefore bulky and cumbersome, not very durable or very portable, and not well-suited for home use or for field training conditions. Up until recently, the prevailing attitude in the medical community had been that the student would learn and practice Cricothyrotomy techniques at an institution or facility supplied with a traditional training device. As a consequence, training, certification and recertification efforts have been traditionally focused on classroom training, with few options for home or other out-of-classroom practice.

Moreover, traditional Cricothyrotomy training components are almost uniformly “stand alone.” That is, they are produced as an individual training device to be used only for Cricothyrotomy training, and cannot be used for other purposes or in conjunction with other medical training devices. Unfortunately, individuals learning Cricothyrotomy procedures will typically also have a need for training in other medical treatment techniques, such as for example, various medical needle insertions techniques. Traditional Cricothyrotomy trainers are not designed for such cross-training purposes.

Recently, a few “portable” or “personal” medical training devices have been introduced, including for example the self-contained needle insertion training systems disclosed in U.S. Pat. Nos. 8,556,634, 8,808,005, 10,380,918 and 10,943,507 (collectively, the “MITS™ Patents”). Such training systems are stand-alone devices that are designed to either augment or to be used in conjunction with traditional classroom training programs. However, the devices covered by the MITS™ Patents have not been capable of providing Cricothyrotomy training.

It therefore would be desirable to have an improved Cricothyrotomy training device that can be used in a traditional classroom setting or as a portable or take-home trainer that can be used in conjunction with classroom training or a classroom trainer, and/or can be used in conjunction with a needle insertion training system, such as for example, one or more of the devices covered by the MITS™ Patents.

### BRIEF DESCRIPTION OF SEVERAL VIEWS OF THE DRAWINGS

The illustrative embodiments of the present invention are shown in the following drawings which form a part of the specification. The drawings described herein are for illustration purposes only and are not intended to limit the scope of the present teachings in any way.

FIG. 1 is a perspective view of a representative first embodiment of a Cricothyrotomy training adjunct, in accordance with the present disclosure.

FIG. 2 is a top view of the Cricothyrotomy training adjunct of FIG. 1.

FIG. 3 is an alternate perspective view of the Cricothyrotomy training adjunct of FIG. 1.

FIG. 4 is a second alternate perspective view of the Cricothyrotomy training adjunct of FIG. 1.

FIG. 5 is a third alternate perspective view of the Cricothyrotomy training adjunct of FIG. 1.

FIG. 6 is a perspective view of the body of a representative MITS™ medical needle training device without endcaps.

FIG. 7 is a side view of the Cricothyrotomy training adjunct of FIG. 1 attached to the representative MITS™ body of FIG. 6 with end caps attached.

FIG. 8 is a side view of the Cricothyrotomy training adjunct and representative MITS™ body of FIG. 7, showing a user stretching a synthetic skin patch over the adjunct and over a synthetic cricoid process membrane (not shown) positioned between the skin patch and the adjunct near the center of the adjunct.

FIG. 9 is a side view of the Cricothyrotomy training adjunct and representative MITS™ body of FIG. 8, showing a user employing a scalpel to cut through the skin patch and membrane near the center of the adjunct.

FIG. 10 is a side view of the Cricothyrotomy training adjunct representative MITS™ body of FIG. 9, showing a representative emergency cricothyroid airway device inserted through the incision in the skin patch and membrane, through the adjunct, and into the MITS™ body.

Corresponding reference numerals indicate corresponding parts throughout the several views of drawings.

### DETAILED DESCRIPTION

The following description is merely representative in nature and is not intended to limit the present disclosure or the disclosure's applications or uses. Before turning to the figures and the various representative embodiments illustrated therein, a detailed overview of various embodiments and aspects is provided for purposes of breadth of scope, context, clarity, and completeness.

Further areas of applicability of the present teachings will become apparent from the description provided herein. It should be understood that the description and specific examples are intended for purposes of illustration only and are not intended to limit the scope of the present teachings.

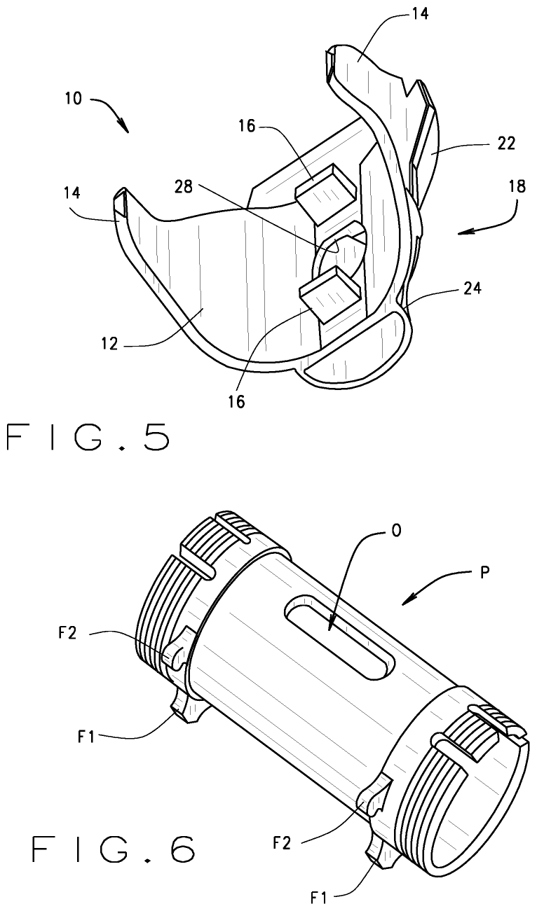

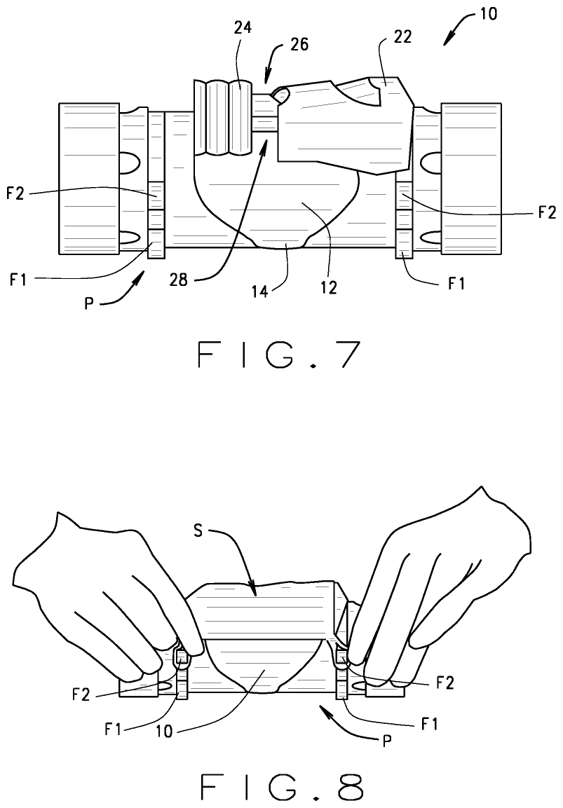

As described and disclosed herein are improvements to embodiments of a modular Cricothyrotomy training adjunct 10 for a medical training device, such as the self-contained needle insertion training platform as disclosed, for example, in U.S. Pat. No. 10,943,507 (hereinafter, the “MITS™ Platform”), which disclosure is incorporated by reference herein. A representative MITS™ Platform P without its endcaps is depicted in FIG. 6, and the adjunct 10 is shown attached to and in use on a representative MITS™ Platform P in FIGS. 7-10. Generally, a self-contained needle insertion training device such as for example the MITS™ Platform P, provides expedient and precise skills training for various medical needle insertion techniques, including for example, intravenous (“IV”), intramuscular, subcutaneous and needle decompression. In various embodiments, the MITS™ Platform P includes a rigid hollow body having at least one sidewall with a training region having a training port or orifice O (see FIG. 6), with the sidewall defining an interior chamber. The body is cylindrical and approximately two to three inches in diameter and approximately six inches long, and has at least one set of feet F1 and F2 positioned near the end caps as shown in FIG. 6. In this embodiment, the feet F2 are configured with a slight downward hook. The MITS™ Platform P additionally includes a removable elastic skin patch S (see FIGS. 7-10) that can be stretched over the MITS™ body to cover the training orifice O in the sidewall. The representative skin patch S is generally rectangular, and has elastic loops at each corner that can be stretched to attach to the feet F2 as shown. One or more simulated cardiovascular veins or arteries can be disposed along an outer surface of the sidewall under the skin patch S.

It is envisioned that the MITS™ Platform P can be used, for example, in the field by military forces to instruct critical combat lifesaving skills to soldiers and host nation forces, as well as providing an excellent commercial training tool for personal use as well as in the classroom setting, and may be used as a foundational component in conjunction with the modular system 10. In particular, the MITS™ Platform P can be sized to approximate the average size of the front portion of a human throat, such that the Platform P can be securely held and stabilized with one hand of the user, leaving the user's other hand free to practice Cricothyrotomy training techniques described herein.

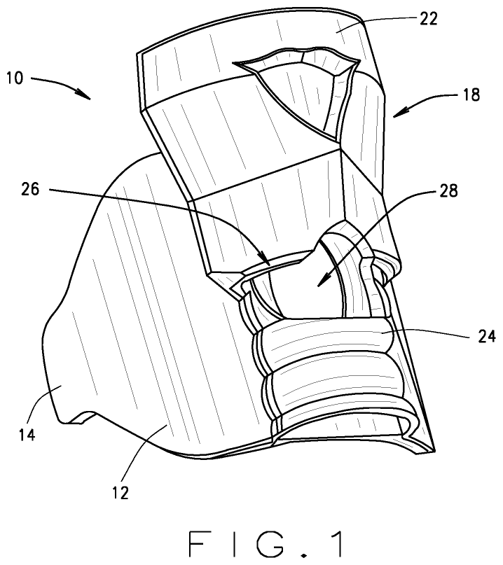

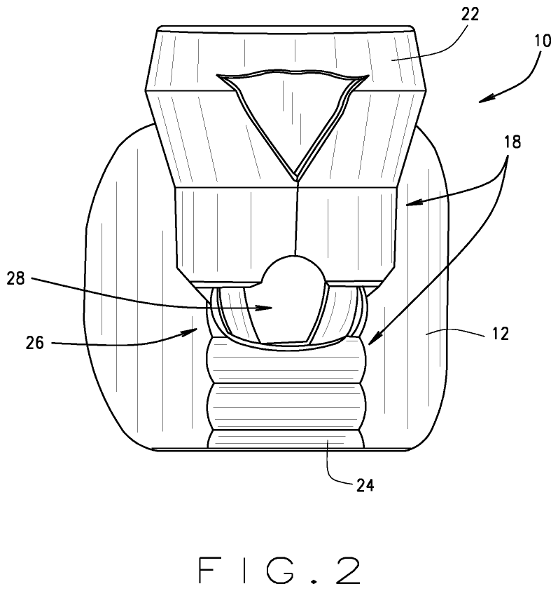

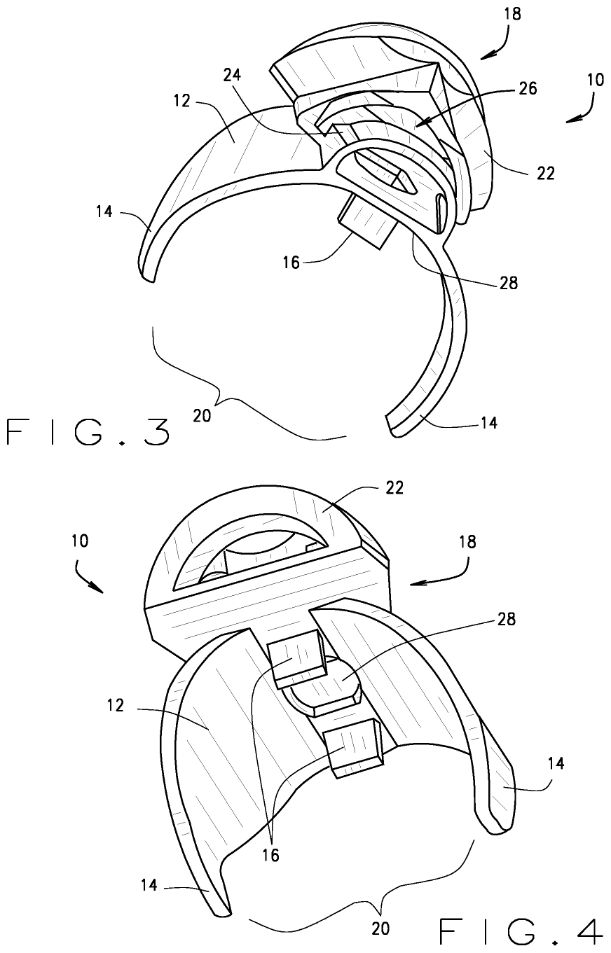

Referring now to FIGS. 1-5, the present disclosure provides a modular Cricothyrotomy training adjunct 10 that comprises a base 12, two generally rectangular curved flanges 14 that extend from the base 12, a pair of flat and rectangular positioning tabs 16, and the anterior aspect of a simulated human larynx 18. The modular adjunct 10 is formed from a substantially rigid, though somewhat elastic plastic, although other materials may be used. The base 12 is a semicircular shell that is approximately 0.125 inch thick, approximately 1.75 inches long, approximately 2.25 inches wide, and has a radius of curvature of approximately 1.0 inch. Each of the two flanges 14 extends downward from and longitudinally along one of the two sides of base 12. The flanges 14 are each approximately 0.625 inches long and 0.75 inches wide, and generally continue the curvature of the portion of the base 12 from which they extend, to collectively form an elastic clamp 20 there between.

Each of the positioning tabs 16 is approximately 0.375 inches wide, 0.30 inches tall, and 0.125 inches thick. The positioning tabs 16 each extend in a perpendicular fashion downward from the underside of the base 12, are oriented parallel to one another, and each is positioned approximately 0.25 inches from its respective end of the base 12.

The larynx anterior aspect 18 is formed on and rises upward from the upper surface of the base 12, and includes an upper structure 22 and a lower structure 24. The upper structure 22 corresponds in shape to the anterior of the cricoid cartilage and the lower end of the thyroid cartilage of a human body. The lower structure 24 includes a series of semicircular ridges that correspond in shape to the upper anterior portion of the trachea cartilage of a human body. The larynx anterior aspect 18 thereby forms a cavity 25 between the base 12 and the upper and lower structures 22 and 24. A first opening 26 is positioned between the upper structure 22 and lower structure 24. The first opening 26 extends across the full width of both the upper structure 22 and lower structure 24, and is approximately 0.500 inches tall at its maximum height. An ovoid second opening 28 in the base 12 is positioned directly below the first opening 26. The second opening 28 is approximately 0.675 inches tall and 0.375 inches wide.

As can be seen and appreciated by one of ordinary skill in the art, and as depicted in FIGS. 7-10, the modular adjunct 10 is designed to releasably clip onto a MITS™ Platform P. The tabs 16 are sized and shaped to fit in each end of the orifice O in the MITS™ Platform P in order to properly orient and align the adjunct 10 when clipped onto the top of the Platform P. As can also be appreciated, the second opening 28, is positioned and oriented on the base 12 so as to align with the needle insertion training orifice O of a MITS™ Platform P (see FIG. 6) when the modular adjunct 10 is properly attached to the Platform. The first opening 26, which is aligned with the second opening 28, also aligns with the training orifice O when the modular adjunct 10 is properly attached to the MITS™ Platform P. This positioning of the modular adjunct 10 on the MITS™ Platform P allows the use of various Cricothyrotomy tools (such as for example, one or more of a cuffed tracheostomy tube or cricothyrotomy catheter, a curved Kelly forceps hemostat, a scalpel, a syringe and a tracheal hook) in association with the modular adjunct 10 to facilitate the insertion of the cuffed tracheostomy tube or cricothyrotomy catheter through the openings 26 and 28 in the modular adjunct 10, through the training orifice O of the MITS™ Platform P, and into the body of the Platform, for emergency Cricothyrotomy training, as depicted in FIGS. 8-10. Thus, the modular adjunct 10 acts as a component of, and utilizes the features of, the training device (such as the MITS™ Platform P) to which it releasably attaches.

In addition, when modular adjunct 10 is properly attached to the MITS™ Platform P, one or more simulated tissue or skin patches, such as the patch S depicted in FIGS. 8-10, can be placed over modular adjunct 10 to further simulate the front of a human throat for emergency Cricothyrotomy training purposes. Preferably, the simulated skin patch S should be slightly stretched over the modular adjunct 10 and attached to the MITS™ Platform P, such as for example as can be accomplished using the skin patch disclosed in U.S. patent application Ser. No. 16/046,724.

Referring now to FIGS. 7-10, a typical use of the modular adjunct 10 with a representative MITS™ Platform P is depicted. FIG. 7 shows the adjunct 10 releasably attached (i.e., clipped onto) to the Platform P. The adjunct 10 is shaped and sized such that the underside of the base 12 matches and generally fits flush against the cylindrical outer surface of the center of the body of the Platform P. Yet, the flanges 14 are curved slightly inward and the distance between the flanges 14 is slightly less than the outer diameter of the center of the Platform P. Consequently, due to the slightly elastic nature of the base 12, the clamp 20 (formed by the flanges 14) can releasably “snap” or “clip” the adjunct 10 into place onto the Platform P. Of course, the shape and dimensions of the adjunct 10 can be adjusted so as to conform to a particular medical training device, such that that adjunct 10 can releasably “snap” or “clip” onto the device while aligning the openings 26 and 28 to an opening in such a platform. Here, as previously described, and as can be appreciated by one of ordinary skill in the art, the adjunct 10 is configured to allow the openings 26 and 28 to align with the orifice O in the Platform P.

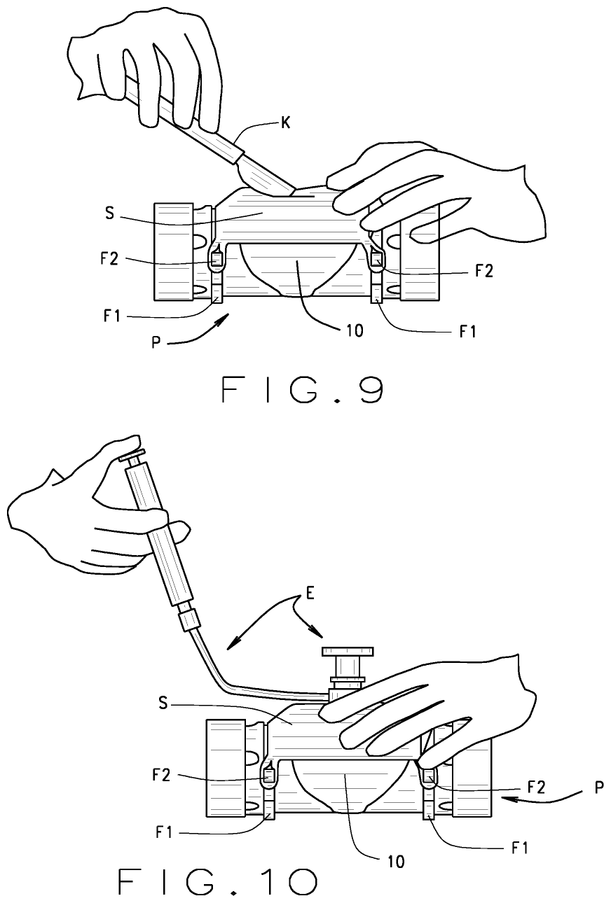

In FIG. 8, a representative simulated skin patch P is stretched over the adjunct 10. Preferably, a simulated cricoid process membrane (not shown) is positioned between the skin S and the adjunct 10 over the opening 26 so as to provide a more accurate simulation for Cricothyrotomy training. In FIG. 9, a user is seen holding the combined training device (i.e., adjunct 10 and Platform P) on a stable surface with the left hand, while using a scalpel K to create an incision above the opening 26 in both the skin S and the simulated membrane. This incision is used for insertion of a cricothyroid airway device. Finally, FIG. 10 depicts a representative emergency cricothyroid airway device E that has been inserted through the incision in the simulated skin S and the simulated cricothyroid membrane, through the openings 26 and 28 in the adjunct 10, through the orifice O in the Platform P, and into the hollow body of the Platform P.

While we have described in the detailed description several configurations that may be encompassed within the disclosed embodiments of this invention, numerous other alternative configurations, that would now be apparent to one of ordinary skill in the art, may be designed and constructed within the bounds of our invention as set forth in the claims. Moreover, the above-described novel mechanisms of the present invention, shown by way of example at 10 can be arranged in a number of other and related varieties of configurations without departing from or expanding beyond the scope of my invention as set forth in the claims. Thus, the description herein is merely exemplary in nature and variations that do not depart from the gist of that which is described are intended to be within the scope of the teachings. Such variations are not to be regarded as a departure from the spirit and scope of the teachings.

For example, the modular adjunct 10 can be configured to attach to other medical training devices, other than the MITS™ Platform P depicted and described in this disclosure, where such devices have an opening or orifice that is sized and shaped to receive, for example, a cuffed tracheostomy tube or cricothyrotomy catheter, through the modular adjunct 10 when the modular adjunct 10 is attached to such a device. Of course, the adjunct 10 may be configured differently to enable mating with such an alternate medical training device, so long as the combination of the adjunct 10 and the device function as disclosed herein and enable Cricothyrotomy training on a medical training device as discussed herein.

In addition, adjunct 10 is not limited to having exactly two openings such as the openings 26 and 28. Rather, the adjunct 10 may, for example, be configured such that there is no separation between the larynx anterior aspect 18 and the base 12 in the vicinity where the upper structure 22 and lower structure 24 meet, such that the adjunct 10 will have a single opening that extends through both the larynx anterior aspect 18 and the base 12.

Further, the first opening 26 and the second opening 28 are not limited to the specific shapes as depicted in the representative embodiment of adjunct 10. Rather, each may differ in size and shape, so long as each adequately aligns with the training orifice O when the modular adjunct 10 is properly attached to a training device (such as for example, the MITS™ Platform P), and each is configured to enable proper Cricothyrotomy training on such training device as discussed herein.

Similarly, the alignment tabs 16 can have varying shapes and sizes, so long as they provide proper alignment between the adjunct 10 and the medical training device to which the adjunct 10 attaches. Further, there may be fewer or more than exactly two tabs 16, and the adjunct 10 can be configured without such tabs 16.

Although the adjunct 10 preferably attaches to a training device (such as for example, the MITS™ Platform P) so as to align the first and second openings 26 and 28 with the training orifice O, the adjunct 10 may alternatively be configured such that the first and second openings 26 and 28 instead align with a different orifice or opening in the training device that is not necessarily used for training purposes—so long as such a configuration allows proper Cricothyrotomy training on such training device as discussed herein.

Also, the features of the adjunct 10 that simulate human body structures, such as for example, the upper structure 22 which correspond in shape to the anterior of the cricoid cartilage and the lower end of the thyroid cartilage of a human body or the lower structure 24's series of semicircular ridges that correspond in shape to the upper anterior portion of the trachea cartilage of a human body, need not be the same as what is depicted in the Figures. Rather, similar configurations—whether more or less anatomically correct—can be employed to replicate these features of the human body.

While the MITS™ Platform P is depicted by preference as cylindrical, it is contemplated that the MITS™ Platform P, and other such training platforms, may be of a wide variety of other shapes and sizes. For example, the MITS™ Platform P may for example be box-shaped, oval, hexagonal or polygonal. In such circumstances, the modular adjunct 10 can be modified or adapted to releasably attach to any such variety or configuration of the MITS™ Platform P (or other medical training device), so long as the adjunct 10 can be configured such that the first and second openings 26 and 28 align with a training orifice of the MITS™ Platform P in a position and manner that allows a user to practice Cricothyrotomy training on the Platform when so positioned.

Depending upon the shape and configuration of the training devices to which the modular adjunct 10 attaches, and the orientation of the orifices or openings in such devices, the modular adjunct 10 may have differing contours and shapes and sizes to accommodate accurate positioning of the adjunct onto the trainer to properly correspond to and mate with such orifices or openings in the trainer.

In addition, other components or features can be added to adjunct 10 to provide more anatomical accuracy. For example, the shape of the larynx anterior aspect 18 may be altered to reflect differences within the norm of human larynx features, or a lower chin structure may be added atop the upper structure 22.

Although the embodiments of the adjunct 10 disclosed and described contemplate the use of a substantially rigid yet slightly elastic polymer, other materials can be used instead—so long as the adjunct 10 is able to be secured to the medical training device, such as the MITS™ Platform P. For example, the adjunct 10 may include fully rigid materials, such as metals components, so long as it also includes portions that can attach to the medical training device in the manner described herein. Further, instead of having a flexible base 12 and attachment flanges 14, the adjunct 10 may include any of a variety of other types of fasteners or attachment devices such as for example, one or more of a clip, a clamp, a ratchet, a belt, a latch, a screw, a bolt, an elastic band, a hook, and a pin.

It is also contemplated that the simulated skin S and the adjunct 10 can alternatively be configured such that the skin S attaches directly to the adjunct 10 instead of attaching to the medical training device to which the adjunct 10 is attached.

Although the embodiment of the adjunct 10 described herein includes a simulated cricothyroid membrane (not shown in Figures) and a skin S, it is recognized that various alternate embodiments of the adjunct 10 may be configured without either one or both of the membrane or the skin S.

The descriptions herein are merely exemplary in nature and, thus, variations that do not depart from the gist of that which is described are intended to be within the scope of the teachings. Such variations are not to be regarded as a departure from the spirit and scope of the teachings.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the representative embodiments and implementations described above without departing from the scope of the disclosure. Accordingly, all matter contained in the above description or shown in the accompanying drawings should be interpreted as illustrative and not in a limiting sense.

It is further to be understood that any processes or steps described herein are not to be construed as necessarily requiring their performance in the particular order discussed or illustrated. It is also to be understood that additional or alternative processes or steps may be employed.

What is claimed is:

1. A modular Cricothyrotomy training adjunct for a medical training device, said device having a body with an inner chamber, said body having an orifice that opens into said inner chamber, said adjunct comprising:
a. a base, said base releasably attaching to said medical training device, said base having a first opening there through; and
b. a simulated larynx having a front face, said simulated larynx having a second opening, said second opening extending through said simulated larynx, said simulated larynx being affixed to said base, said second opening aligning at least in part with first opening, said second opening aligning at least in part with said medical training device orifice when said base attaches to said medical training device.

2. The modular Cricothyrotomy training adjunct of claim 1, further comprising a simulated skin patch, said simulated skin patch being positioned at least in part over said second opening.

3. The modular Cricothyrotomy training adjunct of claim 2, wherein said simulated skin patch releasably attaches to one of said medical training device, said base, and said simulated larynx.

4. The modular Cricothyrotomy training adjunct of claim 1, wherein said simulated larynx has a front face, said front face having an upper structure and a lower structure, said second opening being positioned between said upper and lower structures, one of said upper structure and said lower structure corresponding in shape to one of: (a) the anterior of the cricoid cartilage and lower end of the thyroid cartilage of a human body; and (b) the upper anterior portion of the trachea cartilage of a human body.

5. The modular Cricothyrotomy training adjunct of claim 1, further comprising a fastener, said fastener releasably attaching said base to said medical training device.

6. The modular Cricothyrotomy training adjunct of claim 5, wherein said fastener comprises one of a clip, a clamp, a ratchet, a belt, a latch, a screw, a bolt, an elastic band, a hook, and a pin.

7. The modular Cricothyrotomy training adjunct of claim 1, wherein said base comprises an elastic flange, said elastic flange being positioned and oriented to apply pressure to said medical training device when said base is attached to said medical training device.

8. The modular Cricothyrotomy training adjunct of claim 1, wherein said medical training device comprises a MITS™ Platform.

9. The modular Cricothyrotomy training adjunct of claim 1, further comprising an alignment structure, said alignment structure aligning said base to said medical training device in a desired orientation.

10. The modular Cricothyrotomy training adjunct of claim 1, further comprising simulated cricoid process membrane positioned at least in part over said second opening.

11. The modular Cricothyrotomy training adjunct of claim 1, wherein said first and second openings are contiguous.

12. A modular Cricothyrotomy training system, said system comprising:
a. a medical training device, said device having a body with an inner chamber, said body having an orifice, said orifice opening into said inner chamber;
b. a simulated larynx adjunct, said adjunct having a base with a simulated anterior larynx oriented on one side of said base, said simulated anterior larynx having an opening, said opening shaped and sized to enable Cricothyrotomy training there through; and
C. a fastener, said fastener releasably attaching said adjunct to said medical training device such that said opening aligns with said medical training device orifice in an orientation to allow Cricothyrotomy training using said adjunct when said adjunct is attached to said medical training device.

13. The modular Cricothyrotomy training system of claim 12, further comprising a simulated skin patch, said simulated skin patch being positioned at least in part over said opening.

14. The modular Cricothyrotomy training system of claim 13, wherein said simulated skin patch releasably attaches to one of said simulated anterior larynx adjunct and said medical training device.

15. The modular Cricothyrotomy training system of claim 12, wherein said simulated anterior larynx adjunct comprises a front face, said front face having an upper structure and a lower structure, said opening positioned between said upper and lower structures, one of said upper structure and said lower structure corresponds in shape to one of: (a) the anterior of the cricoid cartilage and lower end of the thyroid cartilage of a human body; and (b) the upper anterior portion of the trachea cartilage of a human body.

16. The modular Cricothyrotomy training system of claim 12, wherein said fastener comprises one of comprises one of a clip, a clamp, a ratchet, a belt, a latch, a screw, a bolt, an elastic band, a hook, and a pin.

17. The modular Cricothyrotomy training adjunct of claim 12, wherein said fastener extends from said base and comprises an elastic flange, said elastic flange being positioned and oriented to apply pressure to said medical training device when said base is attached to said medical training device.

18. The modular Cricothyrotomy training adjunct of claim 12, wherein said medical training device comprises a MITS™ Platform.

19. The modular Cricothyrotomy training adjunct of claim 12, further comprising an alignment structure, said alignment structure aligning said base to said medical training device in a desired orientation.

20. The modular Cricothyrotomy training adjunct of claim 12, further comprising simulated cricoid process membrane positioned at least in part over said opening.
